(19) United States
(12) Patent Application Publication
(10) Pub. No.: US 2009/0262656 A1
(43) Pub. Date: Oct. 22, 2009

(54) METHOD FOR NEW RESOURCE TO COMMUNICATE AND ACTIVATE MONITORING OF BEST PRACTICE METRICS AND THRESHOLDS VALUES

(75) Inventors: Michael J. Branson, Rochester, MN (US); Gregory R. Hintermeister, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, ARMONK, NY (US)

(21) Appl. No.: 12/107,204

(22) Filed: Apr. 22, 2008

(51) Int. Cl. G06F 11/00

(52) U.S. Cl. 370/252

(57) ABSTRACT

A method is provided for monitoring a resource by utilizing proxy metrics provided by a dependent resource. A primary resource is recognized by a dependent resource, where the dependent resource is dependent upon certain capabilities of the primary resource. Metrics of the primary resource upon which the dependent resource needs are determined. Thresholds related to the metrics of the primary resource are determined. The dependent resource communicates the metrics and related thresholds to a central management tool. The metrics and related thresholds are monitored. Also, the dependent resource may act as a proxy for the primary resource, where the central management tool monitors the metrics and the related thresholds of the primary resource via the dependent resource.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

Exemplary embodiments relate to monitoring metrics, and particularly to utilizing a resource to provide proxy metrics of another resource.

2. Description of Background

In today's computer age, the information technology (IT) environment continues to expand. As a new computer is added to an IT environment, a lot of work needs to be done to start monitoring the health of the computer. This problem is multiplied today with virtual servers, storage, and network devices.

For example, every time a new resource is added, the administrator who uses a centralized management tool needs to discover the new resource, get permission to use it, then add monitoring and thresholds so that the health of the new resource is known. Even worse, as new hardware, software, and custom virtual devices are added, the administrator may not know what metrics of the new resource to monitor and the corresponding thresholds in order to accurately know what the health of this new resource is.

A technique is needed to accurately assess the health of resources.

### SUMMARY

In accordance with exemplary embodiments, a method is provided for monitoring a resource by utilizing proxy metrics provided by a dependent resource. A primary resource is recognized by a dependent resource, where the dependent resource is dependent upon certain capabilities of the primary resource. Metrics of the primary resource that measure the capabilities which the dependent resource requires are determined. Thresholds are set on these metrics to indicate levels where the dependent capabilities are in danger of not being met. The dependent resource communicates the metrics and related thresholds to a central management tool. The central management tool monitors the metrics and related thresholds. Further, the dependent resource may act as a proxy for the primary resource, where the central management tool monitors the metrics and the related thresholds of the primary resource via the dependent resource.

In accordance with exemplary embodiments, the “proxy” nature may have two features: determination of metrics and thresholds by proxy (i.e., choosing the metrics and setting the thresholds based on the input of the dependent resource(s); and actually performing the monitoring through a proxy resource. It is contemplated that the monitoring may be performed directly or indirectly. According to exemplary embodiments, the primary resource may also communicate best practices to either the dependent resource or directly to the central management tool in the form of recommended metrics and threshold values.

System and computer program products corresponding to the above-summarized methods are also described and claimed herein.

Additional features and advantages are realized through the techniques of exemplary embodiments. For a better understanding of the invention with advantages and features, refer to the description and to the drawings.

### DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 illustrates an example of a system in which exemplary embodiments may be implemented;

FIGS. 2A and 2B illustrate an example of a process in accordance with exemplary embodiments;

FIG. 3 illustrates a method in accordance with exemplary embodiments; and

FIG. 4 illustrates an example of a computer having capabilities, which may be included in exemplary embodiments.

The detailed description explains exemplary embodiments, together with advantages and features, by way of example with reference to the drawings.

### DETAILED DESCRIPTION OF EXEMPLARY EMBODIMENTS

Exemplary embodiments provide a mechanism to communicate metrics about a device that another device is dependent on and optionally communicate threshold values for those related metrics.

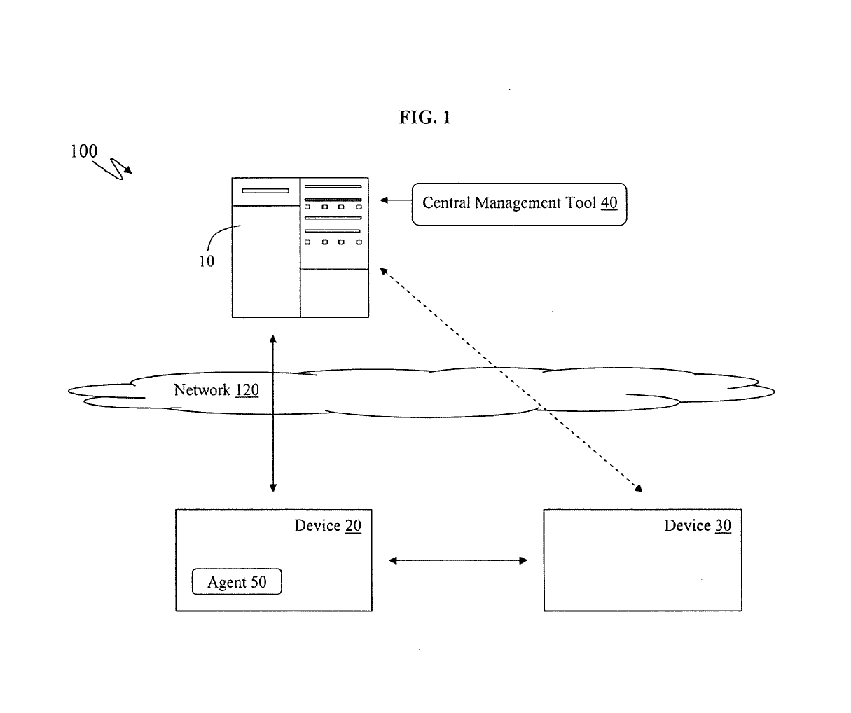

FIG. 1 illustrates an example of a system 100 in which exemplary embodiments may be implemented. A server 10 may be operatively connected to one or more devices 20 to communicate via a network 120. The device 20 may be operatively connected to a device 30. The device 20 may communicate with the device 30 over a network such as the network 120 or a different network. The device 20 may be dependent on device 30 for certain resources. As a non-limiting example, the device 20 may store data on device 30.

The network 120 may include circuit-switched and/or packet-switched technologies and devices, such as routers, switches, hubs, gateways, etc., for facilitating communications. The network 120 may include wireline and/or wireless components utilizing, e.g., IEEE 802.11 standards for providing over-the-air transmissions of communications. The network 120 can also be a packet-switched network as a local area network, a wide area network, a metropolitan area network, an Internet network, or other similar types of networks. The network 120 may include a cellular communications network, a fixed wireless network, a wireless local area network (LAN), a wireless wide area network (WAN), a personal area network (PAN), a virtual private network (VPN), an intranet or any other suitable network.

The server 10 may include a central management tool 40 for monitoring metrics related to hardware and/or software components, and the central management tool 40 may determine the health of the hardware and/or software components based on particular thresholds. The server 10 can monitor metrics (health) of the device 20 via the network 100. However, the operative connection between the server 10 and device 30 is illustrated with a dashed line, because the server 10 may or may not be able to communicate with the device 30, and the server 10 may or may not be able to directly monitor metrics related to the device 30. In accordance with exemplary embodiments, the device 20 is configured to provide proxy metrics (which are related to device 30) to the server 10. The device 20 may utilize agent 50 in providing proxy metrics. The device 20 may provide the proxy metrics for device 30 as the device 20 transmits its own metric information. Also, the device 20 may provide its metric information separate from the metric information related to the device 30. Since the server 10 receives the proxy metrics that correspond to the device 30 from the device 20, the central management tool 40 can indirectly monitor device 30 via the device 20. Moreover, the device 20 and 30 can communicate best practice metric information so that the critical metrics and thresholds are used by the centralized management tool 40.

As an illustration, consider the following non-limiting example. If a network router (device 30) dies, the dependent device (device 20) will no longer be functional, so the dependent device has great interest in making sure the network router's health is monitored. Sometimes the primary resource (device 30) will have the capability of being monitored by the centralized application. But when it is not, exemplary embodiments can monitor the primary resource (device 30) by proxy through the dependent resource (device 20).

There are many parameters from both hardware and software components that can be monitored by the central management tool 40. As a non-limiting example, a network router metric may be communicated as an important metric for the primary virtual server resource (device 20). The centralized management tool 40 may monitor the virtual server (device 20) for that metric, even though the values originate from the network router (device 30).

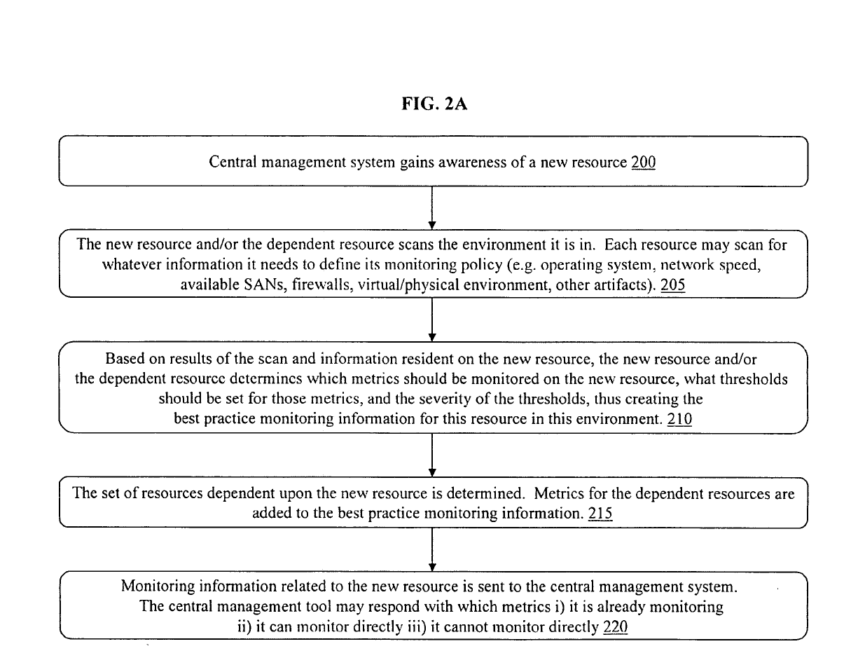

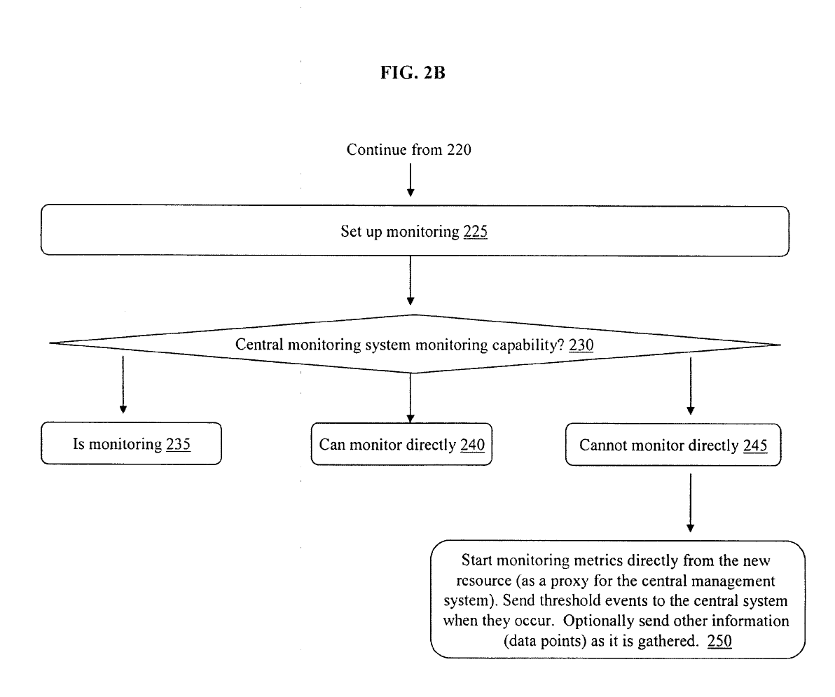

FIGS. 2A and 2B illustrate an example of a process in accordance with exemplary embodiments. The central management tool 40 may discover a new resource (which can represent a software and/or hardware component) at 200. The new resource may be, e.g., the device 30. The existence of the new resource may be provided to the central management tool 40 by the device 20 on behalf of the device 30. In communicating with the server 10, the device 20 may act as a proxy for device 30.

The device 20 may use the agent 50 to scan the environment that the device 20 is in to ascertain, e.g., network speed, available storage area network (SAN), firewalls, and other artifacts at 205. If the device 30 has an agent, the device 30 may scan its environment as well.

The device 20 (and/or device 30) may indicate what metrics should be monitored on the device 30 at 210. For example, the agent of the device 30 may provide metric information to the device 20 or assist the device 20 in obtaining metrics about device 30. Also, the device 20 may obtain metrics related to the device 30 based on various measured parameters. These parameters may be mutual between the device 20 and the device 30. As a non-limiting example, since the device 20 is dependent upon device 30, the agent 50 of device 20 is able to recognize speed in communicating with the device 30.

The agent 50 of the device 20 may determine what metrics (of the device 30) are most important to communicate to the central management tool 40 and determine what the threshold values should be for those metrics at 215. The device 30 may indicate its own metrics to monitor and the related thresholds. Also, the device 20 indicates what metrics are important to monitor for itself including the path to the metric (of device 30). In particular, agent 50 of the device 20 is configured to communicate the metrics of device 20 in addition to the metrics related to the device 30, and these metrics may be communicated individually and/or collectively to the central monitoring tool 40. The metrics and the thresholds of the metrics may be based on, e.g., hardware, operating systems, applications, environment aspects, etc.

Also, the device 20 communicates what tasks (that have been shipped with the device 30) can help troubleshoot problems associated with the device 30. The device 30 may have programs and applications that can be utilized to assist with problems.

The device 20 transmits the metrics of device 30 that it is dependent on and optionally transmits the threshold values for those metrics to the central management tool 40 at 220.

In response to receiving the metric data, the central management tool 40 activates the monitoring based on the recommendations from the device 20 at 225. As such, the administrator can be sure that if anything critical happens on the primary resource (device 30), it will be known to the central management tool 40 on the server 10.

In accordance with exemplary embodiments, the central management tool 40 or the device 20 may determine whether the central management tool 40 can monitor the metric of device 30 directly at 230. For example, the central management tool 40 may already be monitoring the device 30 at 235. The central management tool 40 may be able to monitor the device 30 directly at 240. Also, the central management tool 40 may not be able to monitor the device 30 directly at 245. If it is determined that the central management tool 40 cannot monitor the device 30 directly, the device 20 starts directly monitoring the device 20 as a proxy for the central management tool 40 and provides updates of threshold events and/or provides other information (such as data points) as it is gathered at 250.

As a non-limiting example, the central management tool 40 may not have any knowledge of the new resource, and the central management tool 40 may become aware of the metrics related to the new resource by the dependent resource.

Alternatively, the process may be triggered by a discovery event from a resource management system. Resource discovery itself can be accomplished any number of ways in resource management systems. As one non-limiting example, the management system may discover a new resource and send an event to its management agent running on (or on behalf of) the new resource to indicate that the new resource has been discovered and is known for the first time to this resource management system. The configuration of monitoring that takes place may execute on the agent and/or on the host of the (centralized) management system.

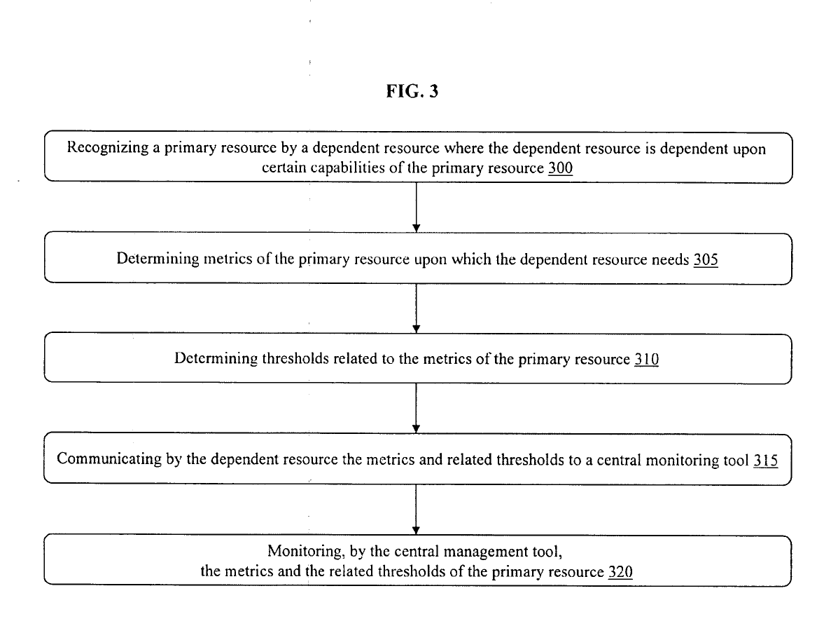

FIG. 3 illustrates a method for monitoring a resource by utilizing proxy metrics provided by a dependent resource in accordance with exemplary embodiments.

A primary resource is recognized by a dependent resource where the dependent resource is dependent upon certain capabilities of the primary resource at 300.

Metrics of the primary resource upon which the dependent resource needs is determined by the dependent resource at 305. As a non-limiting example, the primary resource may be the device 30 and the dependent resource may be the device 20. The device 30 may be memory in which the device 20 stores data. The device 20 recognizes that it is dependent upon the device 30 for storing data.

Thresholds related to the metrics of the primary resource are determined by the dependent resource at 310. The dependent resource communicates the metrics and related thresholds to a central monitoring tool at 315. As a non-limiting example, the agent 50 residing on the device 20 may communicate with an agent on the device 30, and the device 30 can inform device 20 of the necessary metrics to monitor. Also, the device 30 may inform device 20 of the related threshold for those metrics.

Alternatively and/or additionally, the device 20 (agent 50) may determine which metrics of device 30 that are necessary for device 20 to fulfill its goals. The device 20 may also determine the thresholds for these metrics. The device 20 can determine that metrics for device 30 should not drop below a certain threshold. For example, these metrics may include the storage capacity of the device 30, the speed of the communication link between the device 20 and the device 30, etc. Also, the device 20 may recognize/determine that the storage capacity of device 30 should not drop below a certain level, and accordingly, the storage capacity of the device 30 should be monitored. Since the device 20 is dependent on the device 30, the device 20 knows about the nature of the device 30 and the level of service that the device 20 needs from the device 30. So if the device 20 relies on the device 30 for storage, the device 20 could set a threshold on the storage device reaching 95% capacity, because at that point its dependency might not be met. The device 20 may recognize that the speed of the communication link speed should not drop below a certain threshold, and accordingly, the speed of the communication link should be monitored.

In response to receiving the metrics and the related thresholds of the primary resource, the central management tool 40 can monitor the metrics and the related thresholds of the primary resource at 320. Alternatively and/or additionally, the dependent resource can act as a proxy for the primary resource, so that the central management tool 40 can monitor the metrics and the related thresholds of the primary resource via the dependent resource. The device 20 (dependent resource) can push metric information (of the device 30) to the central management tool 40, or the central management tool 40 can pull metric information (of the device 30) from the device 20.

As discussed herein, the dependent resource may be a software component and/or a hardware component, and the primary resource may be a software component and/or a hardware component. In a non-limiting example, the central management tool 40 is incapable of directly monitoring the primary resource.

In accordance with exemplary embodiments, indirect monitoring may be used when the system (e.g., the server 10) cannot directly monitor a device, so the system uses another device that it can monitor to perform the monitoring. As discussed herein, another feature of exemplary embodiments is concerned with what is monitored. Instead of a human administrator deciding what to monitor about the device 30, the devices (such as the device 20) that are dependent on the device 30 communicate their dependency to the central management tool 40 and the metrics/thresholds to monitor in order for this dependency to be met. The central management tool 40 could monitor these metrics/thresholds directly or indirectly, but the identification of the dependencies and the metrics/thresholds required to meet the dependencies are provided by the dependent device (e.g., the device 20).

In accordance with exemplary embodiments, the dependent device 20 can provide the best practice metrics and threshold values. Whether using direct or indirect monitoring, exemplary embodiments can allow the dependent device 20 to decide what metrics to monitor and what thresholds to set instead of relying upon a human administrator to make these decisions.

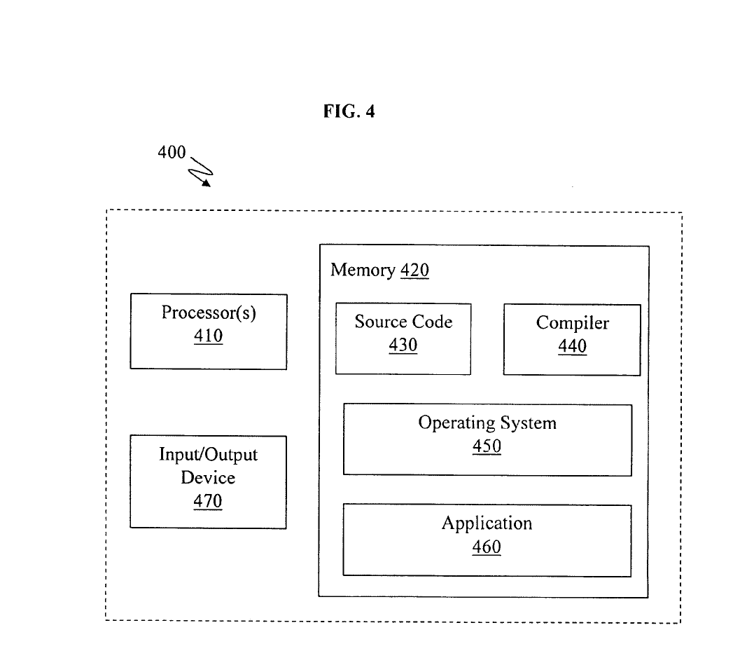

FIG. 4 illustrates an example of a computer 400 having capabilities, which may be included in exemplary embodiments. Various methods, procedures, and techniques discussed above may also utilize the capabilities of the computer 400. One or more of the capabilities of the computer 400 may be incorporated in any of the element discussed herein.

Generally, in terms of hardware architecture, the computer 400 may include one or more processors 410, memory 420, and one or more input and/or output (I/O) devices 470 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 410 is a hardware device for executing software that can be stored in the memory 420. The processor 410 can be virtually any custom made or commercially available processor, a central processing unit (CPU), a data signal processor (DSP), or an auxiliary processor among several processors associated with the computer 400, and the processor 410 may be a semiconductor based microprocessor (in the form of a microchip) or a macroprocessor.

The memory 420 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 420 may incorporate electronic, magnetic, optical, and/or other types of storage media. Note that the memory 420 can have a distributed architecture, where various components are situated remote from one another, but can be accessed by the processor 410.

The software in the memory 420 may include one or more separate programs, each of which comprises an ordered listing of executable instructions for implementing logical functions. The software in the memory 420 includes a suitable operating system (O/S) 450, compiler 440, source code 430, and an application 460 (which may be one or more applications) of the exemplary embodiments. As illustrated, the application 460 comprises numerous functional components for implementing the features and operations of the exemplary embodiments. The application 460 of the computer 400 may represent various applications, agents, software components, etc., but the application 460 is not meant to be a limitation.

The operating system 450 may control the execution of other computer programs, and provides scheduling, input-output control, file and data management, memory management, and communication control and related services.

The application 460 may be a source program, executable program (object code), script, or any other entity comprising a set of instructions to be performed. When a source program, then the program is usually translated via a compiler (such as the compiler 440), assembler, interpreter, or the like, which may or may not be included within the memory 420, so as to operate properly in connection with the O/S 450. Furthermore, the application 460 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 470 may include input devices such as, for example but not limited to, a mouse, keyboard, scanner, microphone, camera, etc. Furthermore, the I/O devices 470 may also include output devices, for example but not limited to, a printer, display, etc. Finally, the I/O devices 470 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 470 also include components for communicating over various networks, such as the Internet or an intranet.

When the computer 400 is in operation, the processor 410 is configured to execute software stored within the memory 420, to communicate data to and from the memory 420, and to generally control operations of the computer 400 pursuant to the software. The application 460 and the O/S 450 are read, in whole or in part, by the processor 410, perhaps buffered within the processor 410, and then executed.

When the application 460 is implemented in software it should be noted that the application 460 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 460 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 460 is implemented in hardware, the application 460 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is understood that the computer 400 includes non-limiting examples of software and hardware components that may be included in various devices and systems discussed herein, and it is understood that additional software and hardware components may be included in the various devices and systems discussed in accordance with exemplary embodiments.

The capabilities of the present invention can be implemented in software, firmware, hardware, or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiment have been described, it will be understood that those skilled in the art, both now and in the future, may make various improvements and enhancements which fall within the scope of the claims which follow. These claims should be construed to maintain the proper protection for the invention first described.

What is claimed is:

1. A method for monitoring a resource by utilizing proxy metrics provided by a dependent resource, comprising:
recognizing a primary resource by a dependent resource, wherein the dependent resource is dependent upon certain capabilities of the primary resource;
determining metrics of the primary resource upon which the dependent resource needs;
determining thresholds related to the metrics of the primary resource;
communicating by the dependent resource the metrics and related thresholds to a central management tool; and
monitoring the metrics and related thresholds of the primary resource.

2. The method of claim 1, further comprising acting as a proxy by the dependent resource for the primary resource, wherein the central management tool monitors the metrics and the related thresholds of the primary resource via the dependent resource.

3. The method of claim 1, wherein the dependent resource is at least one of a software component and a hardware component; and
wherein the primary resource is at least one of a software component and a hardware component.

4. The method of claim 1, wherein the central management tool is incapable of directly monitoring the primary resource, so the central management tool monitors the metrics and the related thresholds of the primary resource via the dependent resource.
